(19) United States
(12) Patent Application Publication
(10) Pub. No.: US 2013/0083301 A1
(43) Pub. Date: Apr. 4, 2013

(54) REFLECTION APPARATUS AND BEAM PROJECTOR HAVING THE SAME

(71) Applicant: Samsung Electronics Co., Ltd., Gyeonggi-do (KR)

(72) Inventors: Dong-Hi LEE, Gyeonggi-do (KR); Jung-Kee Lee, Gyeonggi-do (KR); Seong-Ha Park, Gyeonggi-do (KR); Yong-Kwan Kim, Gyeonggi-do (KR); Young-Kang Cho, Gyeonggi-do (KR)

(73) Assignee: Samsung Electronics Co., Ltd., Gyeonggi-do (KR)

(21) Appl. No.: 13/628,577

(22) Filed: Sep. 27, 2012

(30) Foreign Application Priority Data
Sep. 30, 2011 (KR) 10-2011-0099546

(51) Int. Cl. G03B 21/28

(52) U.S. Cl. 353/99

(57) ABSTRACT

A reflection apparatus for a beam projector, and a beam projector including the reflection apparatus are provided. The reflection apparatus reflects and projects incident light from a projection optical system of the beam projector to an external surface, and includes a first mirror for reflecting the incident light from the projection optical system, and a second mirror that receives the light reflected from the first mirror and reflects the received light to the external surface.

### PRIORITY

This application claims priority under 35 U.S.C. §119(a) to Korean Patent Application Serial No. 10-2011-0099546, which was filed in the Korean Intellectual Property Office on Sep. 30, 2011, the entire disclosure of which is hereby incorporated by reference.

### BACKGROUND OF THE INVENTION

1. Field of the Invention

The present invention relates generally to a beam projector, and more particularly, to a beam projector and a reflection apparatus for the same.

2. Description of the Related Art

Recently, smaller beam projectors, e.g., pocket beam projectors, have been commercialized. Further, a pico beam projector module, which has a size of 10 cc or less has also been introduced.

Generally, projection beam projectors form enlarged images onto a relatively flat surface, e.g., the ground or a wall, which is used as a screen.

Conventionally, to form an enlarged image onto a surface, a portable projection beam projector projects a beam onto the surface with a projection optical system using a single mirror or no mirror.

When a separate mirror is not used to form the enlarged image on the surface, in order to increase a size of the image projected onto the surface, a magnification of the projection optical system has to be increased, or the projection optical system itself must be moved away from the surface.

Further, when the enlarged image is formed on the surface by using one mirror, to prevent a beam reflected by the mirror from being interfered by the projection optical system or a tool supporting the projection optical system (that is, to prevent the reflected beam from being covered), the projection optical system and the mirror cannot be located close to each other. Additionally, in order to obtain an image of a desired size, a light exit angle of the projection optical system must be large in size, which increases the size of the mirror, and hence, the size of the beam projector.

### SUMMARY OF THE INVENTION

Accordingly, the present invention is designed to address at least the problems and/or disadvantages described above and to provide at least the advantages described below.

Accordingly, an aspect of the present invention is to provide a portable beam projector of a subminiature size, which projects a large image.

In accordance with an aspect of the present invention, a reflection apparatus for a beam projector is provided, which reflects incident light from a projection optical system of the beam projector to an external screen. The reflection apparatus includes a first mirror for reflecting the incident light from the projection optical system, and a second mirror that receives the incident light reflected from the first mirror and reflects the received light to the screen.

### BRIEF DESCRIPTION OF THE DRAWINGS

The above and other aspects, features, and advantages of certain embodiments of the present invention will be more apparent from the following detailed description taken in conjunction with the accompanying drawings, in which:

FIG. 1 illustrates a portable beam projector according to an embodiment of the present invention;

FIG. 2 illustrates a reflection apparatus according to an embodiment of the present invention;

FIG. 3 illustrates a projection optical system according to an embodiment of the present invention;

FIG. 4 illustrates first and second front-end mirrors disposed in their closed states according to an embodiment of the present invention;

FIGS. 5 through 7 illustrate various structures of a reflection apparatus according to embodiments of the present invention;

FIGS. 8 through 10 illustrate a moving apparatus of a reflection apparatus according to an embodiment of the present invention;

FIG. 11 illustrates another moving apparatus of a reflection apparatus according to an embodiment of the present invention;

FIG. 12 illustrates an illumination optical system according to an embodiment of the present invention;

FIG. 13 illustrates a small projector according to an embodiment of the present invention;

FIG. 14 illustrates a light-beam tracing simulation result according to an embodiment of the present invention; and

FIG. 15 illustrates a prism according to an embodiment of the present invention.

### DETAILED DESCRIPTION OF EMBODIMENTS OF THE INVENTION

Hereinafter, various embodiments of the present invention will be described in detail with reference to the accompanying drawings. Various details found in the following description are provided only to help general understanding of the present invention, and it is apparent to those of ordinary skill in the art that some modifications or changes may be made to the details within the scope of the present invention. In addition, in the following description, well-known functions or structures will not be described to avoid unnecessarily obscuring the subject matter of the present invention.

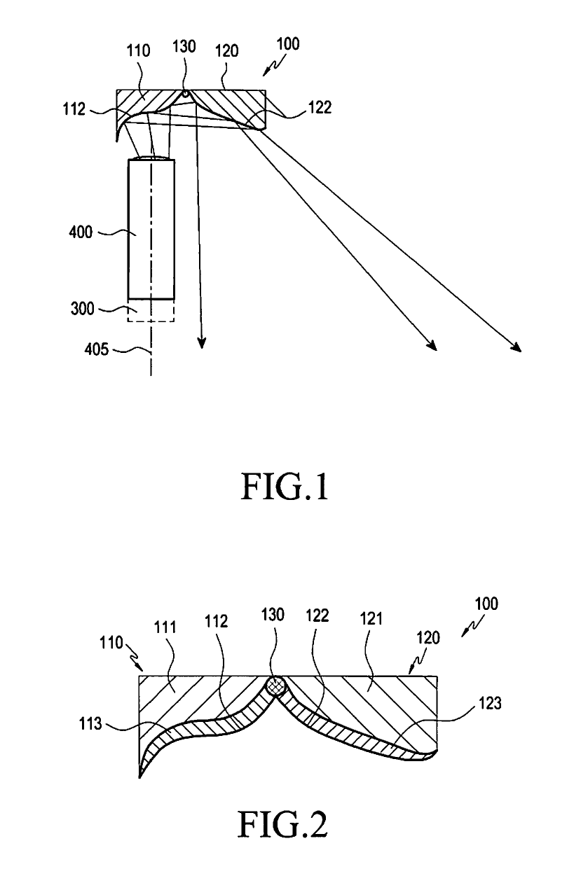

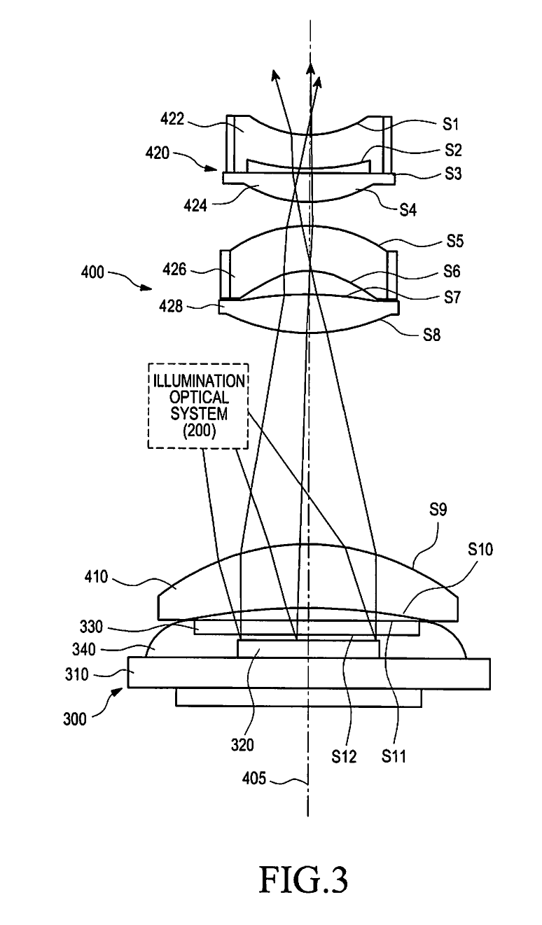

FIG. 1 illustrates a portable beam projector according to an embodiment of the present invention, FIG. 2 illustrates a reflection apparatus according to an embodiment of the present invention, and FIG. 3 illustrates a projection optical system according to an embodiment of the present invention.

Referring to FIGS. 1 to 3, the beam projector includes an illumination optical system 200, a display device 300, a projection optical system 400, and a reflection apparatus 100.

The illumination optical system 200 includes at least one light source and at least one lens for uniformly illuminating the display device 300 by adjusting light from the at least one light source.

The display device 300 reflects the incident light from the illumination optical system 200 in pixel units and forms an image.

The display device 300 displays an image in pixel units, includes pixel devices 320 corresponding to a preset resolution, and displays the image through on/off driving of the pixel devices 320. For example, the display device 300 includes a small flat-plate display device, such as a Digital Micro-Mirror Device (DMD), which includes micro mirrors arranged in an M×N matrix structure (e.g., 1280×720, 854×480, etc.). Each micro mirror rotates to a position corresponding to an on state and a position corresponding to an off state according to a driving signal. In the on state, a micro mirror reflects the incident light at an angle that displays an image on a surface, and in the off state, the micro mirror reflects the incident light at an angle that does not display an image on the surface. That is, the light reflected from the micro mirror in the off state does not exit to the outside after passing through the projection optical system 400, and the light reflected from the micro mirror in the on state passes through the projection optical system 400 and exits to the outside to project an image on the surface.

The display device 300 includes a circuit board 310 for providing a drive signal to the pixel devices 320, pixel devices 320 mounted on the circuit board 310, a glass cover 330 for protecting the pixel devices 320 from an external environment, and a sealing layer 340 for protecting an exposed top surface of the circuit board 310 from the external environment.

The projection optical system 400, which has an optical axis 405, includes a field lens 410 and a projection lens 420. The field lens 410 and the projection lens 420 are aligned on the optical axis 405. Typically, the optical axis 405 refers to an axis such that rotation of a corresponding optical device around the axis does not cause optical change. Alignment on the optical axis 405 means that a center of curvature of an optical device of a corresponding optical system is positioned on the optical axis 405, or a symmetric point (i.e., a symmetric center) or center point of the optical device is positioned on the optical axis.

The field lens 410 receives light from the illumination optical system 200 and directs the received light to be incident to the display device 300 at a uniform angle. The field lens 410 receives the light reflected from the display device 300 and directs the light after reduces a beam spot size of the light. The light reflected from the display device 300 has a large beam spot size, such that light loss may be large from light that is not transferred to the projection lens 420. Further, the field lens 410 condenses the light reflected from the display device 300 and reduces the beam spot size of the light, thereby allowing a maximum amount of light to be transferred to the projection lens 420.

The projection lens 420 receives the light with the beam spot size adjusted from the field lens 410, and forms a focus of the light onto the projection surface. That is, the projection lens 420 is automatically or manually moved to adjust a focal length, and an image displayed on the display device 300 is enlarged or reduced based on the focal length and displayed on the surface.

Table 1 shows numerical data of optical devices forming the projection optical system 400. Specifically, in Table 1, a radius of curvature of an i^{th} optical surface Si, a thickness or air gap of the i^{th} optical surface Si (or a distance from the i^{th} optical surface Si to an (i+1)^{th} optical surface), D, a refractive index at a line d (587.5618 nm) of the i^{th} optical surface Si, N, and an Abbe's number of the i^{th} optical surface Si, V, are shown. In addition, units of the radius of curvature and thickness are mm. A number of an optical surface, i, is sequentially added from the reflection apparatus 100 to the display device 300.

TABLE 1

| | Radius of | | | | |
|---|---|---|---|---|---|
| Surface | curvature | between | | | |
| number | (mm) | surfaces | D (mm) | N | V |
| 1 | −2.50 | 1-2 | 1.30 | 1.5311 | 55.80 |
| 2 | −4.65 | 2-3 | 0.10 | 1.0000 | |
| 3 | 13.00 | 3-4 | 1.78 | 1.5311 | 55.80 |
| 4 | −4.84 | 4-5 | 1.99 | 1.0000 | |
| 5 | 7.56 | 5-6 | 0.97 | 6.3200 | 23.00 |
| 6 | 3.07 | 6-7 | 1.88 | 1.0000 | |
| 7 | | 7-8 | 2.50 | 1.6204 | 60.34 |
| 8 | −8.12 | 8-9 | 8.04 | 1.0000 | |
| 9 | 10.80 | 9-10 | 3.00 | 1.6584 | 50.85 |
| 10 | 40.80 | 10-11 | 0.60 | 1.0000 | |
| 11 | | 11-12 | 0.65 | 1.5069 | 63.10 |
| 12 | | 12- | 0.71 | 1.0000 | |
| | | Display | | | |
| | | Device | | | |

In Table 1, first through sixth optical surfaces S1 through S6 are aspheric surfaces, and when a corresponding optical surface is a planar surface, a radius of curvature is not shown and a refractive index of the air is 1.

An aspheric definitional equation is expressed in Equation (1).

$$z = \frac{{ch}^{2}}{1 + SQRT \{ 1 - ( 1 + k ) {c}^{2} {h}^{2} \}} + A {h}^{4} + {Bh}^{6} + {Ch}^{8} + {Dh}^{10} + {Eh}^{12} + {Fh}^{14} + {Gh}^{16} \qquad ( 1 )$$

In Equation (1), z indicates a distance from a center (or vertex) of an optical surface along the optical axis 405, h indicates a distance perpendicular to the optical axis 405, c indicates a curvature at the center of the optical surface (reciprocal of a radius of curvature), k indicates a conic coefficient, and A, B, C, D, E, F, and G(=0) indicate aspheric coefficients.

The aspheric coefficients for respective aspheric surfaces of Table 1 are shown below in Table 2.

TABLE 2
Aspheric parameters

| Surface | k | A | B | C | D | E | F |
|---|---|---|---|---|---|---|---|
| 1 | −0.5868604 | 0.02061595 | −0.001949 | 0.00021047 | −1.59E−05 | 7.49E−07 | −1.28E−08 |
| 2 | −1.16E+00 | 1.06E−02 | −0.000804 | 4.41E−05 | −3.03E−06 | 8.95E−08 | 2.92E−10 |
| 3 | −1.72E+00 | −3.78E−03 | 0.0002273 | −5.05E−06 | −2.94E−06 | 3.28E−07 | −1.69E−08 |
| 4 | −5.72E−01 | 6.52E−05 | 0.0001916 | −2.90E−05 | 1.84E−06 | −2.62E−08 | −4.35E−09 |
| 5 | −2.58E−01 | −1.65E−03 | 0.0001027 | −9.10E−06 | 7.09E−07 | −2.79E−08 | 4.08E−10 |
| 6 | −8.46E−01 | −7.19E−03 | 0.0004096 | −2.58E−05 | 1.35E−06 | −4.42E−08 | 6.09E−10 |

The following description of a form of an optical surface is based on Table 1, but an optical surface of each lens forming the projection optical system may be a spherical or aspheric surface.

Referring to FIG. 3, a projection lens 420 of the projection optical system 400 includes first through fourth lenses 422, 424, 426, and 428 that are sequentially disposed from the reflection apparatus 100 to the display device 300.

The first lens 422 has first and second optical surfaces S1 and S2, which are convex toward the display device 300. The first and second optical surfaces S1 and S2 are aspheric surfaces, respectively.

The second lens 424 has third and fourth optical surfaces S3 and S4, which are biconvex, aspheric surfaces, respectively. As a combination of the first and second lenses 422 and 424, a doublet lens may be used.

The third lens 426 has fifth and sixth optical surfaces S5 and S6, which are convex toward the reflection apparatus 100. The fifth and sixth optical surfaces S5 and S6 are aspheric surfaces, respectively.

The fourth lens 428 has seventh and eighth optical surfaces S7 and S8, which are plano-convex surfaces. The seventh and eighth optical surfaces S7 and S8 are spherical surfaces, respectively. As a combination of the third and fourth lenses 426 and 428, a doublet lens may be used. Although not illustrated in FIG. 3, at least one of the optical surfaces of the fourth lens 428 may be an aspherical surface.

A field lens 410 of the projection optical system 400 is a single lens. The field lens 410 has ninth and tenth optical surfaces S9 and S10, which are convex toward the reflection apparatus 100. The ninth and tenth optical surfaces S9 and S10 are spherical surfaces, respectively. Although not illustrated in FIG. 3, at least one of the optical surfaces of the field lens 410 may be an aspherical surface.

The reflection apparatus 100 receives light from the projection optical system 400 and reflects the light towards the surface to form an image on the surface. The reflection apparatus 100 includes a first front-end mirror 110, a second front-end mirror 120, and a rotation shaft 130.

In the following description, terms such as a rear end and a front end follow a direction from the display device 300 to the reflection apparatus 100. The reflection apparatus 100 is positioned on the front end (or front surface) of the projector.

The first front-end mirror 110 is spaced apart from a front surface of the projection optical system 400 along the optical axis 405, such that the optical axis 405 (or an extending line thereof) of the projection optical system 400 passes a first reflection surface 112 of the first front-end mirror 110. That is, the first reflection surface 112 (i.e., an outer surface) of the first front-end mirror 110 faces a front surface (i.e., a first optical surface) of the projection optical system 400. In FIG. 3, the expression “the first reflection surface 112 faces the front surface of the projection optical system 400” means that they are disposed such that light exiting from the projection optical system 400 along the optical axis 405 is directly incident to the first reflection surface 112. The first reflection surface 112 may be a spherical or aspherical surface. Preferably, the optical axis 405 (or an extending line thereof) of the projection optical system 400 passes through the center of the first reflection surface 112. The first front-end mirror 110 reflects the incident light from the projection optical system 400 toward the second front-end mirror 120.

Referring to FIG. 2, the first front-end mirror 110 includes a first substrate 111 and a first reflection layer 113 laminated on a surface of the first substrate 111. An outer surface of the first reflection layer 113 corresponds to the first reflection surface 112. Selectively, a first protection layer, which is transparent, may be further laminated on the surface of the first reflection layer 113. For example, the first front-end mirror 110 may have a structure in which a dielectric layer or metallic layer having high reflectivity (90% or higher, preferably, 99% or higher) is laminated on a substrate (e.g., glass) having a back surface, which is a planar surface, and a front surface, which is a spherical or aspheric surface, or a back surface and a front surface, both of which are planar surfaces.

Although not illustrated in FIG. 2, the first front-end mirror 110 may include the first substrate and a reflection surface 112 corresponding to a surface of the first substrate. The first substrate is formed of a metallic material, and the surface of the first substrate is finely ground to have characteristics of the reflection surface.

The second front-end mirror 120 is spaced apart from the projection optical system 400, such that the optical axis 405 (or an extending line thereof) of the projection optical system 400 does not pass a second reflection surface 122 of the second front-end mirror 120. That is, the second reflection surface 122 (i.e., the outer surface) of the second front-end mirror 120 does not face either the front end (i.e., the first optical surface) of the projection optical system 400 or the first reflection surface 112. The second reflection surface 122 extends from a first end at a position adjacent to an end of the first reflection surface 112 in a direction away from the optical axis 405. The second reflection surface 122 may be a spherical or aspheric surface.

The second front-end mirror 120 reflects the incident light directly from the first front-end mirror 110 toward the surface. That is, the incident light is reflected from the first front-end mirror 110 to the second front-end mirror 120, through the air, without passing through another reflection or refraction device.

Referring to FIG. 2, the second front-end mirror 120 includes a second substrate 121 and a second reflection layer 123 laminated on a surface of the second substrate 121. An outer surface of the second reflection player 123 corresponds to the second reflection surface 122. Selectively, a second protection layer may be further laminated on the surface of the second reflection layer 123. The second front-end mirror 120 may have a structure in which a dielectric layer or metallic layer having high reflectivity (90% or higher, preferably, 99% or higher) is laminated on a substrate (e.g., glass) having a back surface, which is a planar surface, and a front surface, which is a spherical or aspheric surface, or a back surface and a front surface, both of which are planar surfaces.

Although not illustrated in FIG. 2, the second front-end mirror 120 may include the second substrate and a reflection surface 122 corresponding to a surface of the second substrate. The second substrate is formed of a metallic material, and the surface of the second substrate is finely ground to have characteristics of the reflection surface.

Although not illustrated in FIG. 2, the first and second reflection surfaces 112 and 122 may continuously extend. In this case, the first and second front-end mirrors 110 and 120 share a common substrate of a single material, and the first and second reflection surfaces 112 and 122 are functionally divided from the ground surface of the common substrate. Further, the first and second reflection surfaces 112 and 122 may be functionally divided from the surface of a high-reflectivity dielectric or metallic layer laminated on the common substrate.

The first and second reflection surfaces 112 and 122 may be implemented by various combinations of surface forms, for example, a combination of aspheric and concave surfaces, a combination of aspheric and convex surfaces, a combination of aspheric and planar surfaces, a combination of planar and aspheric surfaces, etc.

The rotation shaft 130 is connected with the first and second front-end mirrors 110 and 120, and any one or both of the first and second front-end mirrors 110 and 120 may rotate with respect to the rotation shaft 130. For example, the rotation shaft 130 may have a hinge structure applied to a typical folder-type cellular phone.

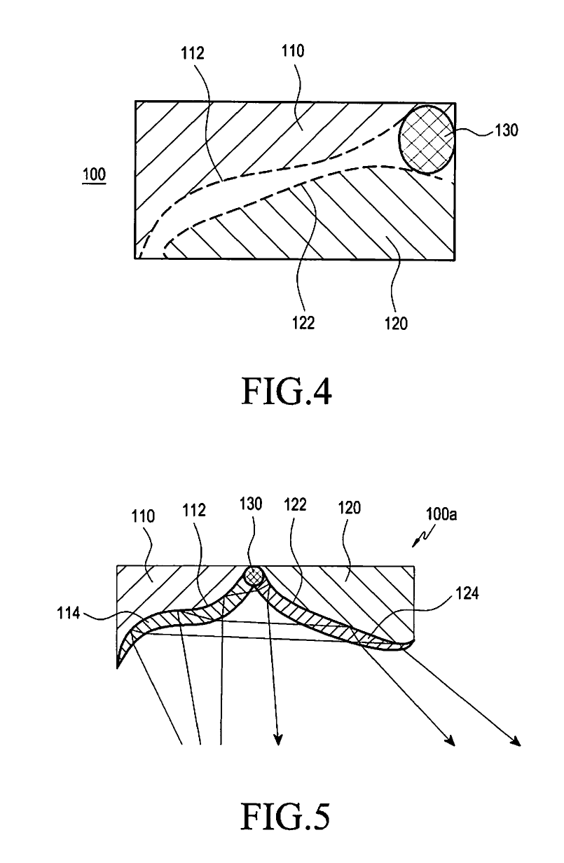

FIG. 4 illustrates the first and second front-end mirrors 110 and 120 in their closed states.

By rotating about the rotation shaft 130, the first and second front-end mirrors 110 and 120 may be in a closed (or folded) states or an opened (or unfolded) state. In the closed state, the first and second reflection surfaces 112 and 122 face each other, as illustrated in FIG. 4, and in the opened state, the first and second reflection surfaces 112 and 122 do not face each other, as illustrated in FIG. 2.

As described above, the reflection apparatus 100 according to an embodiment of the present invention includes two mirrors, i.e., the first and second front-end mirrors 110 and 120, and the projection optical system 400 and the first front-end mirror 110 are positioned relatively close to each other, and the light reflected from the first front-end mirror 110 is directly incident to the second front-end mirror 120. Because the first front-end mirror 110 is positioned close to the projection optical system 400, the size of the first front-end mirror 110 can be minimized and the magnification of the first front-end mirror 110 can be designed considering the size of the second front-end mirror 120. The magnification of the second front-end mirror 120 is designed by being adjusted to fit a size of an image to be projected onto the screen, thereby implementing a subminiature beam projector.

FIGS. 5 through 7 illustrate various structures of a reflection apparatus according to embodiments of the present invention.

Referring to FIG. 5, in a reflection apparatus 100a, the first front-end mirror 110 includes the first protection layer 114 and the second front-end mirror 120 includes a second protection layer 124. Both the first protection layer 114 and the second protection layer 124 are transparent. Incident light is refracted in the first protection layer 114 and the second protection layer 124.

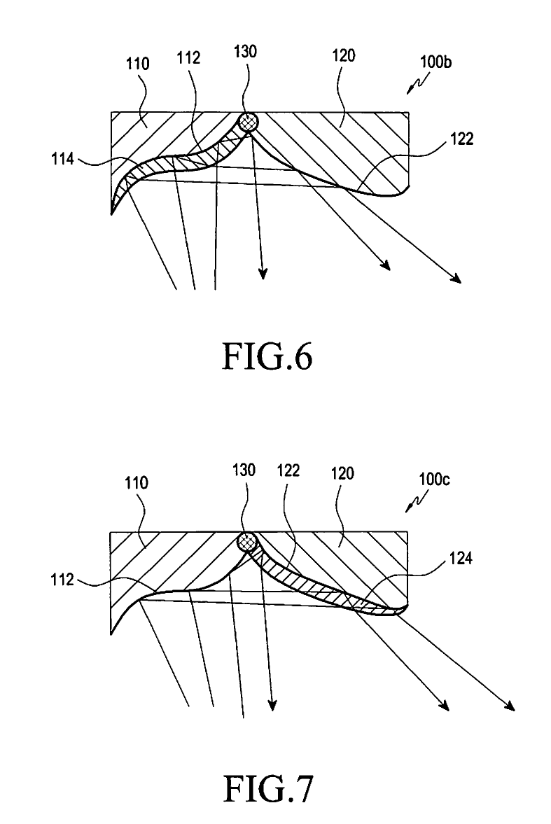

Referring to FIG. 6, in a reflection apparatus 100b, the first front-end mirror 110 includes the first protection layer 114, which is transparent, and the second front-end mirror 120 does not include a second protection layer.

Referring to FIG. 7, in a reflection apparatus 100c, the first front-end mirror 110 does not include a first protection layer and the second front-end mirror 120 includes the second protection layer 124, which is transparent.

For example, referring to FIG. 5, the light exiting from the projection optical system 400 is refracted by the first protection layer 114 and then is incident to the first reflection surface 112, and the light reflected by the first reflection surface 112 is refracted by the second protection layer 124 and then is incident to the second reflection surface 122. The light reflected by the second reflection surface 122 is projected to a display surface.

A beam projector in accordance with an embodiment of the present invention may include various apparatuses for moving the reflection apparatus 100 along the optical axis 405 of the projection optical system 400.

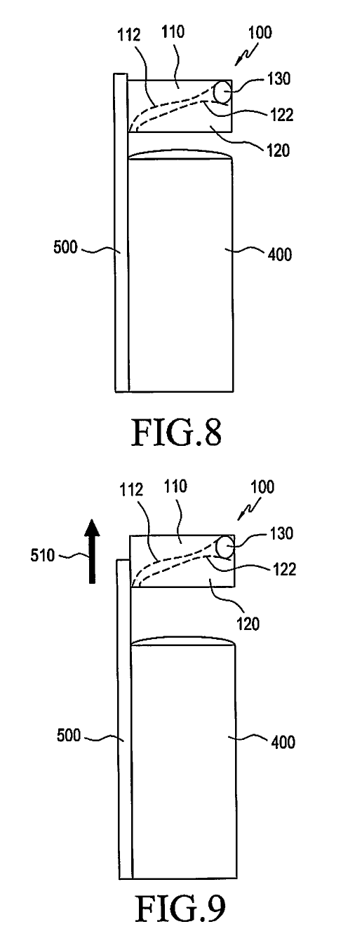

FIGS. 8 through 10 illustrate a moving apparatus of a reflection apparatus according to an embodiment of the present invention. In each of these figures, a side end of the projection optical system 400 and a side end of the reflection apparatus 100 are supported by a guide 500.

FIG. 8 illustrates the projection optical system 400 and the reflection apparatus 100 close to each other. Specifically, in FIG. 8, the reflection apparatus 100 is in a closed state.

In FIG. 9, for use of the beam projector, the reflection apparatus 100 moves back from the projection optical system 400 along the guide 500 in the direction of an upward arrow 510. Accordingly, the reflection apparatus 100 is moved far enough away from the projection optical system 400, such that the reflection apparatus 100 may be changed into an opened state.

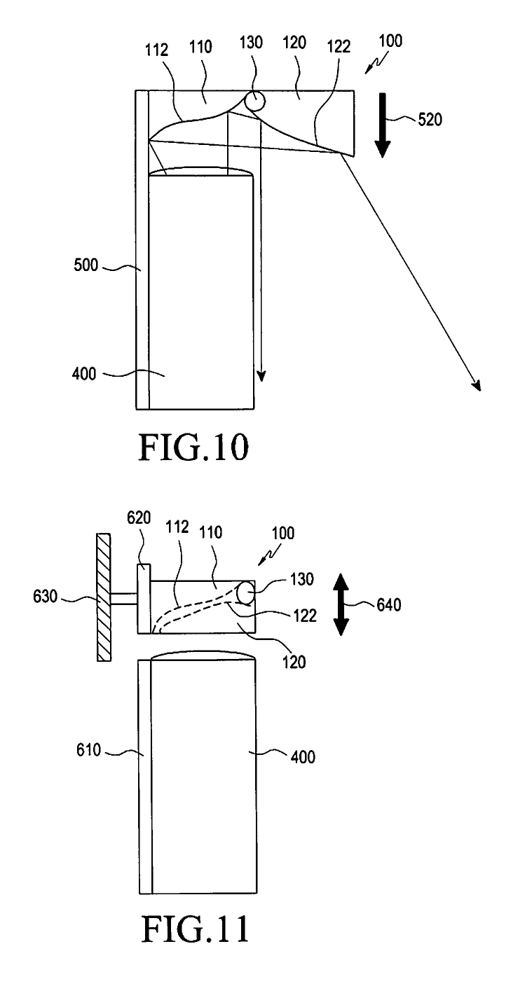

In FIG. 10, the opened-state reflection apparatus 100 moves forward to the projection optical system 400 along the guide 500 in the direction of a downward arrow 520 to maintain a preset interval with the projection optical system 400. At this time, the beam projector is ready for beam projection.

FIG. 11 illustrates another moving apparatus for a reflection apparatus according to an embodiment of the present invention.

Referring to FIG. 11 the moving apparatus includes a first support portion 610 that supports the projection optical system 400, a second support portion 620 that supports the reflection apparatus 100, and a guide 630 that movably supports the second support portion 620. The second support portion 620 moves along the guide 630 in the direction of an upward/downward arrow 640 while supporting the reflection apparatus 100.

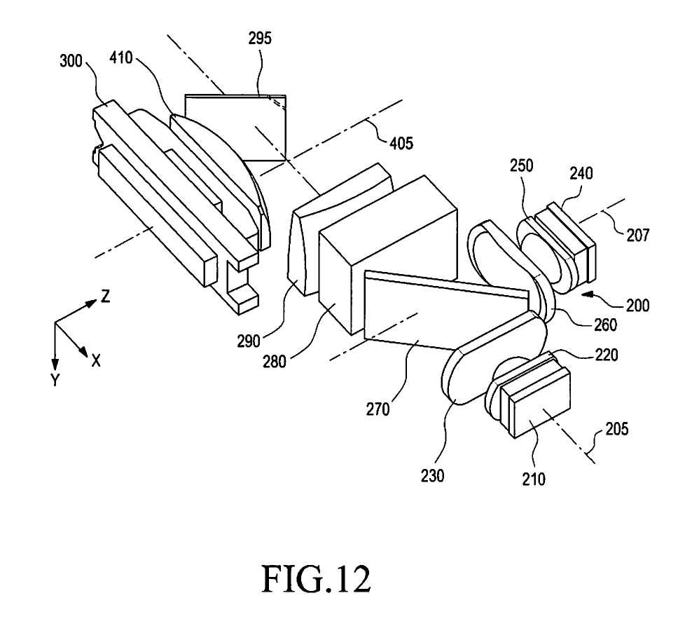

FIG. 12 illustrates an illumination optical system according to an embodiment of the present invention.

Referring to FIG. 12, the illumination optical system 200, which has a first auxiliary optical axis 205 and a second auxiliary optical axis 207, includes first and second light sources 210 and 240, first through fourth collimating lenses 220, 230, 250, and 260, a filter 270, an equalization lens 280, a condensing lens 290, and an intermediate mirror 295. The second light source 240, and the third and fourth collimating lenses 250 and 260 are aligned on the second auxiliary optical axis 207, and the other optical devices of the illumination optical system 200 are aligned on the first auxiliary optical axis 205. Although a plurality of light sources whose output lights are mixed to generate a white light are used in FIG. 12, other light source configurations may be used. For example, one light source (e.g., a wavelength-variable light source) capable of outputting lights in various colors may be used, three light sources corresponding to three primary colors may be used, or a white light source may be used together with one or more color filters.

The first light source 210 outputs a first primary-color light, which travels along the first auxiliary optical axis 205. For example, the first light source 210 is a Light Emitting Diode (LED) outputting a green light. The first light source 210 outputs the first primary-color light, which is emitted at a predetermined angle with respect to the first auxiliary optical axis 205. Alternatively, a collimating lens may be integrated into the first light source 210, and in this case, the first collimating lens may be removed.

The first and second collimating lenses 220 and 230 receive the first primary-color light emitted from the first light source 210, collimate the receive first primary-color light, and then output the collimated first primary-color light. Collimation refers to reducing an emission angle of the light, and ideally, causing the light to travel in parallel without convergence or emission.

The first primary-color light output from the first light source 210 may be emitted in one direction, and in this case, as each collimating lens, a lens whose at least one surfaces are aspheric surfaces may be used. Here, for gradual collimation of the first primary-color light output from the first light source 210 (that is, gradual paralleling of the first primary-color light by the first and second collimating lenses 220 and 230) or divisional collimation in two directions which are perpendicular to each other (that is, collimation of the first primary-color light in a first direction (e.g., an Y-axis direction) by the first collimating lens 210 and collimation of the first primary-color light in a second direction (e.g., a Z-axis direction) perpendicular to the first direction by the second collimating lens 230), the first and second collimating lenses 220 and 230 which form a pair are used, but one collimating lens may also be used.

The Z axis matches the optical axis 405 of the projection optical system 400.

The second light source 240 outputs second and third primary-color lights, which travel along the second auxiliary optical axis 207. For example, as the second light source 240, one or two LEDs outputting a red light and a green light may be used.

The third and fourth collimating lenses 250 and 260 receive the second and third primary-color lights emitted from the second light source 240, collimate the received second and third primary-color lights, and then output the collimated second and third primary-color lights.

Alternatively, the second and third primary-color light sources may exist separately, and in this case, each collimating lens may exist in front of each primary-color light source. For example, another filter may be positioned in front of the filter 270 on the first auxiliary optical axis 205 (that is, positioned between the third primary-color light source and the filter 270 on the second auxiliary optical axis 207) to pass light from the third primary-color light source positioned on the second auxiliary optical axis 207 and to reflect light from the second primary-color light source positioned in almost perpendicular to the second auxiliary optical axis 207 and at the same time, in almost parallel with the first auxiliary optical axis 205.

The filter 270 reflects the second and third primary-color lights input from the fourth collimating lens 260 to cause the lights to travel along the first auxiliary optical axis 205. Also, the filter 270 passes the first primary-color light input from the second collimating lens 230. The filter 270 may be disposed to form an angle of 45° with the first auxiliary optical axis 205, and may reflect the second and third primary-color lights at an angle of 90°. However, the filter 270 is not necessarily disposed at an angle of 45° with the first auxiliary optical axis 205 at all times, and such a disposition is merely an example.

The filter 270 includes a wavelength selective filter (or a dichroic filter) or a prism for selectively performing transmission or reflection according to a wavelength, or a wavelength-independent filter such as a beam splitter, a half mirror, etc. For example, the wavelength selective filter may be implemented by laminating a plurality of thin films on a glass substrate. Using the filter 270, the first through third primary-color lights travel along the same first auxiliary optical axis 205.

The equalization lens 280 intensity-equalizes and then outputs the light input from the filter 270. That is, the equalization lens 280 makes the distribution of the intensity of the light uniform on a Y-Z plane. For example, the equalization lens 280 includes a general fly-eye lens. Using the equalization lens 280, an aspect ratio of the light is matched to that of the display device 300, and chromatic uniformity is improved.

The condensing lens 290 condenses the light input from the equalization lens 280 onto the surface of the display device 300.

The intermediate mirror 295 receives the condensed light from the condensing lens 290 and reflects the light toward the display device 300. The intermediate mirror 295 may have a structure in which a high-reflectivity dielectric layer or metallic layer is laminated on the substrate. As indicated by a dotted line in FIG. 12, at least one corner of the intermediate mirror 295 is cut at an angle, which is not a right angle, and thus is processed into an inclined surface.

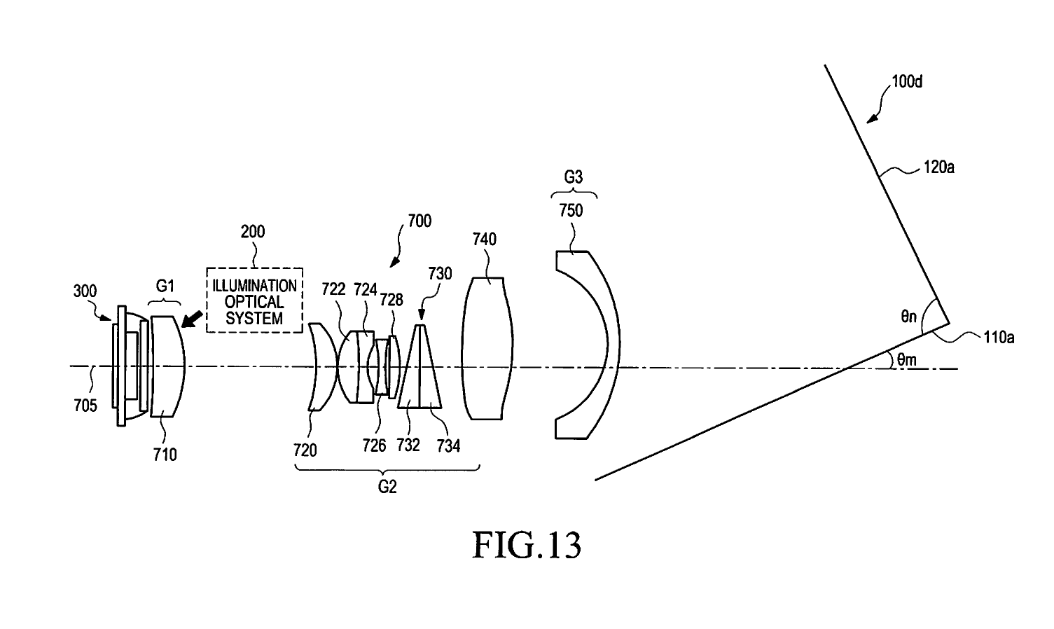

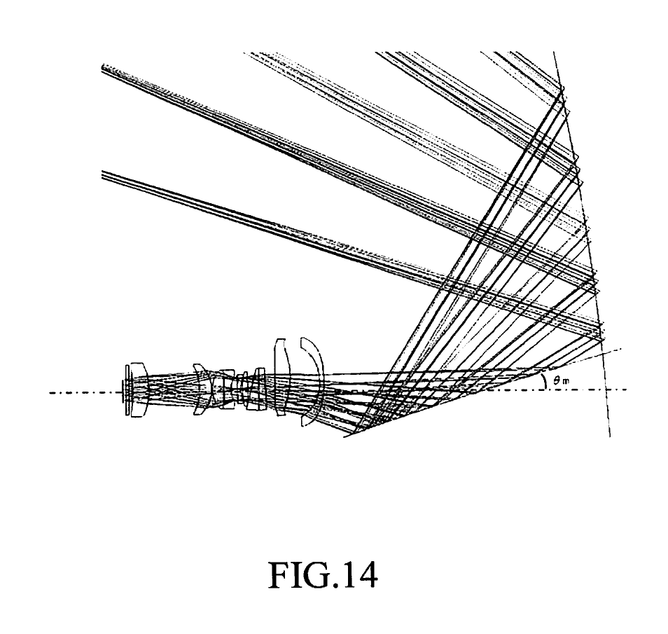

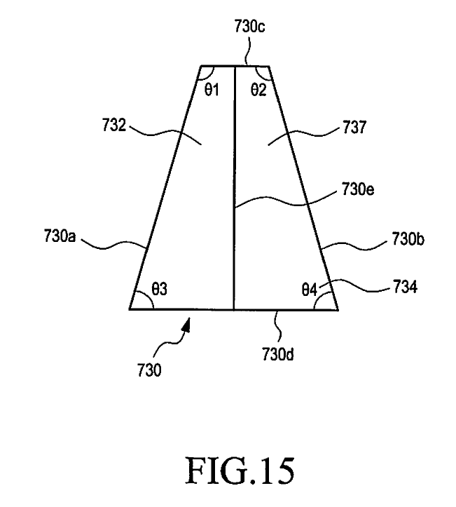

FIG. 13 illustrates a small projector according to an embodiment of the present invention, FIG. 14 illustrates a light-beam tracing simulation result according to an embodiment of the present invention, and FIG. 15 illustrates a prism according to an embodiment of the present invention.

Referring to FIG. 13, the projector includes the illumination optical system 200, which illuminates the display device 300, which reflects light from the illumination optical system 200 in pixel units to form an image, and a projection optical system 700, which projects the light reflected from the display device 300 to an external screen, i.e., projection surface.

The illumination optical system 200 includes at least one light source and at least one lens for uniformly illuminating the display device 300 by adjusting the light incident from the at least one light source.

The display device 300 reflects the incident light from the illumination optical system 100 in pixel units to form an image.

The projection optical system 700, which has an optical axis 705, includes first through third lens groups G1, G2, and G3, and a reflection apparatus 100d having a first front-end mirror 110a and a second front-end mirror 120a. The term “lens group” refers to a group of at least one optical device having a capability of refracting the light as well as lenses.

The display device 300, the first lens group G1 including a first group 710, and second through sixth lenses 720 through 728 of the second lens group G2 are aligned on the optical axis 705, and a seventh lens 740 of the second lens group G2, the third lens group G3 including an eighth lens 750, and the reflection apparatus 100d are non-axially aligned. The expression “non-axially aligned” means that the optical axis 705 or an extending line thereof passes through a corresponding optical device, but a central axis of the optical device is not matched with the optical axis 705. For a prism 730, the optical axis 705 is positioned at a point corresponding to a half of a total height of the prism 730.

Tables 3 and 4 show numeric data of optical devices that form the projection optical system 700. In Table 3, an angle θm formed by the first front-end mirror 110a (that is, the first reflection surface) and the optical axis 705 is 15°, and in Table 4, the angle θm formed by the first front-end mirror 110a and the optical axis 705 is 32°. A number of an optical surface, i, is sequentially added from the display device 300 to the reflection apparatus 100d.

TABLE 3

| Surface | Description | C | T | N | V |
|---|---|---|---|---|---|
| 1 | Display panel | infinity | 0.30 | | |
| 2 | Cover glass | infinity | 0.65 | 1.51 | 63.1 |
| 3 | | infinity | 0.6 | | |
| 4 | Lens 1 | −40.80 | 3 | 1.66 | 50.85 |
| 5 | | −10.80 | 9.01 | | |
| 6 | Lens 2 | −11.99 | 2.25 | 1.53 | 55.8 |
| 7 | | −5.33 | 0.10 | | |
| 8 | Lens 3 | 4.93 | 2.06 | 1.74 | 44.85 |
| 9 | Lens 4 | −47.41 | 1.23 | 1.79 | 25.68 |
| 10 | | 3.71 | 1.14 | | |
| 11 | Lens 5 | 14.99 | 0.7 | 1.63 | 23.3 |
| 12 | | 4.97 | 0.29 | | |
| 13 | Lens 6 | 13.13 | 1.01 | 1.79 | 25.68 |
| 14 | | −31.81 | 0.6 | | |
| 15 | Prism 1 | infinity | 1.3 | 1.74 | 44.85 |
| 16 | Prism 2 | infinity | 1.3 | 1.74 | 44.85 |
| 17 | | infinity | 1.64 | | |
| 18 | Lens 7 | −37.09 | 2.79 | 1.63 | 23.3 |
| 19 | | −10.46 | 5.18 | | |
| 20 | Lens 8 | −9.20 | 0.77 | 1.53 | 55.8 |
| 21 | | −28.82 | 44.19 | | |
| 22 | Mirror 1 | 695.65 | 0.00 | | |
| 23 | Mirror 2 | 0.00 | 0.00 | | |

TABLE 4

| Surface | Description | C | T | N | V |
|---|---|---|---|---|---|
| 1 | Display panel | infinity | 0.30 | | |
| 2 | Cover glass | infinity | 0.65 | 1.51 | 63.1 |
| 3 | | infinity | 0.6 | | |
| 4 | Lens 1 | −40.80 | 3 | 1.66 | 50.85 |
| 5 | | −10.80 | 9.01 | | |
| 6 | Lens 2 | −15.38 | 2.62 | 1.53 | 55.8 |
| 7 | | −5.97 | 0.10 | | |
| 8 | Lens 3 | 5.36 | 2.26 | 1.74 | 44.85 |
| 9 | Lens 4 | −15.44 | 0.80 | 1.79 | 25.68 |
| 10 | | 4.29 | 1.37 | | |
| 11 | Lens 5 | −5.30 | 0.7 | 1.63 | 23.3 |
| 12 | | 27.80 | 0.41 | | |
| 13 | Lens 6 | 48.17 | 1.20 | 1.79 | 25.68 |
| 14 | | −6.35 | 0.6 | | |
| 15 | Prism 1 | infinity | 1.3 | 1.74 | 44.85 |
| 16 | Prism 2 | infinity | 1.3 | 1.74 | 44.85 |
| 17 | | infinity | 0.85 | | |
| 18 | Lens 7 | −49.35 | 2.27 | 1.63 | 23.3 |
| 19 | | −30.00 | 17.17 | | |
| 20 | Lens 8 | −12.12 | 2.70 | 1.53 | 55.8 |
| 21 | | −23.77 | 40.00 | | |
| 22 | Mirror 1 | 408.00 | 0.00 | | |
| 23 | Mirror 2 | 0.00 | 0.00 | | |

In Tables 3 and 4, first, fifth, seventh, and eighth lenses 710, 726, 740, and 750 are bi-aspheric lenses, and each reflection surface of the first and second front-end mirrors 110a and 120a is an aspheric surface. When a corresponding optical surface is a planar surface, a radius of curvature is infinite and a refractive index of the air is 1. A radius of curvature of an aspheric surface is a value measured at the center of the aspheric surface.

Table 5 shows aspheric coefficients of respective aspheric surfaces of Table 3, and Table 6 show aspheric coefficients of respective aspheric surfaces of Table 4.

TABLE 5

| Description | K | A | B | C | D | E | F |
|---|---|---|---|---|---|---|---|
| Lens 1 | 0.00E+00 | −0.00052 | −1.90E−05 | 1.00E−06 | −7.63E−08 | 0.00E+00 | 0.00E+00 |
| | 0.00E+00 | 0.000907 | −2.13E−06 | 1.84E−07 | 2.79E−09 | 0.00E+00 | 0.00E+00 |
| Lens 5 | 0.00E+00 | −0.00063 | −0.000352 | 4.10E−05 | −3.49E−06 | 0.00E+00 | 0.00E+00 |
| | 0.00E+00 | −0.0043 | −0.000213 | 3.45E−05 | −2.46E−06 | 0.00E+00 | 0.00E+00 |
| Lens 7 | 0.00E+00 | 2.66E−04 | 2.91E−06 | 7.70E−08 | −2.67E−10 | 0.00E+00 | 0.00E+00 |
| | 0.00E+00 | 2.75E−04 | 5.45E−06 | −3.51E−08 | 2.18E−09 | 0.00E+00 | 0.00E+00 |
| Lens 8 | 0.97781 | −0.00017 | 2.68E−06 | −2.04E−07 | 8.07E−09 | −1.08E−10 | 5.68E−13 |
| | 12.13976 | −0.00041 | 9.89E−07 | 6.52E−09 | −6.45E−11 | 6.48E−13 | −7.54E−14 |

TABLE 6

| Description | K | A | B | C | D | E | F |
|---|---|---|---|---|---|---|---|
| Lens 1 | 0.00E+00 | −0.00022 | 7.60E−06 | 8.68E−07 | −8.01E−08 | 0.00E+00 | 0.00E+00 |
| | 0.00E+00 | 0.000599 | 1.01E−05 | 2.17E−07 | −2.81E−08 | 0.00E+00 | 0.00E+00 |
| Lens 5 | 0.00E+00 | −0.0019 | 7.58E−05 | −1.91E−05 | 3.86E−07 | 0.00E+00 | 0.00E+00 |
| | 0.00E+00 | −0.00209 | 0.000173 | −1.41E−05 | 6.37E−07 | 0.00E+00 | 0.00E+00 |
| Lens 7 | 0.00E+00 | 4.54E−04 | 6.28E−06 | −2.66E−07 | 4.13E−09 | 0.00E+00 | 0.00E+00 |
| | 0.00E+00 | 4.64E−04 | 6.17E−06 | −1.33E−07 | 1.54E−09 | 0.00E+00 | 0.00E+00 |
| Lens 8 | 1.154818 | −0.0004 | 5.45E−06 | −1.77E−07 | 6.40E−09 | −1.08E−10 | 7.69E−13 |
| | 4.499708 | −0.00031 | 1.91E−06 | 5.41E−09 | −1.23E−10 | −5.53E−14 | 9.09E−15 |

The following description of a form of an optical surface is based on Tables 3 and 4. However, an optical surface of each optical device of the projection optical system 700 may be a spherical or aspheric surface.

The first lens group G1 includes the first lens 710 and has a positive refractive power. The first lens 710 receives light from the illumination optical system 200 and causes the light to be incident to the display device 300 at a uniform angle. The first lens 710 matches the light to the display device 300, considering overfill. That is, the first lens 710 causes the reflected light to be incident to an area that is greater than or equal to an area of pixel devices of the display device 300. The first lens 710 receives the light reflected from the display device 300, and after reducing the beam spot size of the light, outputs the light.

The first lens 710 has fourth and fifth optical surfaces S4 and S5, which are concave-convex in a direction from the display device 300 to the reflection apparatus 100d. The fourth and fifth optical surfaces S4 and S5 are aspheric surfaces.

The second lens group G2 includes second through seventh lenses 720 through 728 and 740, and a prism 730, and has a positive refractive power. The second lens group G2 changes an optical path by using the prism 730, and includes an iris surface, thus controlling a total light quantity. The expression “changes the optical path” means that a principal light ray traveling along an optical axis (to be matched with the optical axis) travels at a preset angle (i.e., with an inclination or a tilt) with respect to the optical axis. The changing of the optical path (that is, change of a traveling path of the principal light beam) generally occurs by the prism or the mirror.

For example, the light incident to a planar mirror at an angle of 45° is reflected at an angle of 45°, such that the optical path is changed into 90° by the planar mirror.

Although not illustrated in FIG. 13, an iris having an opening that is equal to an area of a rear-end optical surface of the fifth lens 726 is positioned between the fourth lens 724 and the fifth lens 726.

The second lens 720 has sixth and seventh optical surfaces S6 and S7, which are concave-convex. The sixth and seventh optical surfaces S6 and S7 are spherical surfaces.

The third lens 722 has eighth and ninth optical surfaces S8 and S9, which are biconvex. The eighth and ninth optical surfaces S8 and S9 are spherical surfaces. The third and fourth lenses 722 and 724 form a doublet lens, and bonded optical surfaces of the third and fourth lenses 722 and 724 have the same curvature, such that in Tables 3 and 4, data of the rear-end optical surface of the third lens 722 is omitted.

The fourth lens 724 has ninth and tenth optical surfaces S9 and S10, which are biconcave. The ninth and tenth optical surfaces S9 and S10 are spherical surfaces.

The fifth lens 726 has eleventh and twelfth optical surfaces S11 and S12, which are convex-concave. The eleventh and twelfth optical surfaces S11 and S12 are aspheric surfaces.

The sixth lens 728 has thirteenth and fourteenth optical surfaces S13 and S14, which are biconvex. The thirteenth and fourteenth optical surfaces S13 and S14 are spherical surfaces.

FIG. 15 illustrates the prism 730 in more detail.

Referring to FIG. 15, the prism 730 is generally in the form of a trapezoid, and may be formed by bonding a rear portion 732 and a front portion 734 formed of the same material. Alternatively, the prism 730 may be formed integrally as one piece, which does not need a subsequent bonding process, through injection or the like.

An angle formed by a rear-end oblique side 730a of the prism 730 and the optical axis 705, which are not parallel with each other, (that is, a gradient of the rear-end oblique side 730a) is larger than a gradient of the front-end oblique side 730b. The rear-end oblique side 730a, a bonded surface 730e, and the front-end oblique side 730b correspond to fifteenth through seventeenth optical surfaces S15, S16, and S17 in Tables 3 and 4, respectively.

In FIG. 15, the prism 730 is in the form of a trapezoid, and for a particular oblique side, a sum of an interior angle of an upper side 730c and an interior angle of a lower side 730d is 180° (that is, θ1+θ3=180°, θ2+θ4=180°). For example, interior angles of the upper side 730c of the prism 430 may be summed up to 102.5° and 100.7°. The prism 730 is made of a single material.

The prism 730 changes an optical path, and aberration and distortion generated due to the change of the optical path may be removed by the seventh and eighth lenses 740 and 750.

The seventh lens 740 has eighteenth and nineteenth optical surfaces S18 and S19, which are concave-convex. The eighteenth and nineteenth optical surfaces S18 and S19 are aspheric surfaces.

The central axis of the seventh lens 740 is spaced apart from the optical axis 705 by a preset distance. The seventh lens 740 refracts the light passing through the prism 730 to cause the light to travel at a preset angle with respect to the optical axis 705. That is, the seventh lens 740 changes an optical path, and in other words, a principal light ray traveling along the optical axis 705 (traveling to be matched with the optical axis) travels at a preset angle with respect to the optical axis.

The third lens group G3 includes the eighth lens 750 and has a negative refraction power. The eighth lens 750 has twentieth and twenty-first optical surfaces S20 and S21, which are concave-convex. The twentieth and twenty-first optical surfaces S20 and S21 are aspheric surfaces.

The eighth lens 750 increases the angle formed by the principal light beam passing through the seventh lens 740 and the optical axis 705. That is, like the seventh lens 740, the eighth lens 750 changes the optical path, and further increases an inclination angle of the principal light beam. The central axis of the eighth lens 750 is spaced apart from the optical axis 705 by a preset distance.

The reflection apparatus 100d receives light from the projection optical system 700, and reflects the light toward the screen, thus forming an image on the projection surface. The reflection apparatus 100d includes the first front-end mirror 110a and the second front-end mirror 120a. The reflection apparatus 100 is positioned in the front end (or the front surface) of the projector.

The first front-end mirror 110a is spaced apart from the front surface of the projection optical system 700 along the optical axis 705 to intersect the optical axis 705 (or an extending line thereof) of the projection optical system 700. That is, the first front-end mirror 110a faces the front surface (that is, the twenty-first optical surface) of the projection optical system 700. The surface (or the first reflection surface) of the first front-end mirror 110a may be a spherical or aspheric surface. In Table 3, the first reflection surface corresponds to a twenty-second optical surface.

The first front-end mirror 110a reflects the light incident from the projection optical system 700 toward the second front-end mirror 120a. The first front-end mirror 110a forms a preset angle with the optical axis 705, and preferably, the inclination angle of the first front-end mirror 110a, θm, is set in a range of 15° through 32°.

The second front-end mirror 120a is spaced apart from the projection optical system 700, such that the optical axis 705 (or an extending line thereof) of the projection optical system 700 does not pass the second reflection surface (that is, the outer surface) of the second front-end mirror 120a. The second reflection surface 122 may be a spherical or aspheric surface.

The second front-end mirror 120a does not face either the front surface (that is, the twenty-first optical surface) of the projection optical system 700 or the first reflection surface. The second front-end mirror 120a extends from the first end at a position adjacent to the end of the first front-end mirror 110a in a direction away from the optical axis 705. The second front-end mirror 120a forms a preset angle with the first front-end mirror 110a. For example, an angle between the first front-end mirror 110a and the second front-end mirror 120a, θn, is set in a range of 96° through 106°. The second front-end mirror 120a reflects the incident light directly from the first front-end mirror 110a toward the screen. In Table 3, the second reflection surface corresponds to a twenty-third optical surface.

Each lens group of the projection optical system 700 may be moved to adjust a focus.

For example, when the reflection apparatus 100d is fixed, respective lens groups may be moved at the same time. When the respective lens groups are fixed, the reflection apparatus 100d may be moved, and when the first lens group G1 and the reflection apparatus 100d are fixed, the second lens group G2 and the third lens group G3 may be moved in opposite directions at the same time.

As is apparent from the foregoing description, by using a reflection apparatus having a first mirror and a second mirror, the size of the reflection apparatus can be designed to be small while still projecting a large image, thereby providing a subminiature beam projector and providing characteristics suitable for a structure of a beam projector that can be carried at all times.

While the present invention has been particularly shown and described with reference to certain embodiments thereof, it will be understood by those of ordinary skill in the art that various changes in form and details may be made therein without departing from the spirit and scope of the present invention as defined by the following claims and their equivalents.

What is claimed is:

1. A reflection apparatus for a beam projector, which reflects and projects incident light from a projection optical system of the beam projector to an external surface, the reflection apparatus comprising:
a first mirror for reflecting the incident light from the projection optical system; and
a second mirror that receives the light reflected from the first mirror and reflects the received light to the external surface.

2. The reflection apparatus of claim 1, wherein the first mirror reflects the incident light in a direction perpendicular to an optical axis of the projection optical system, and
wherein the second mirror reflects the received light in parallel with the optical axis.

3. The reflection apparatus of claim 1, wherein the first mirror comprises:
a first substrate; and
a first reflection layer laminated on a surface of the first substrate.

4. The reflection apparatus of claim 3, wherein the second mirror comprises:
a second substrate; and
a second reflection layer laminated on a surface of the second substrate.

5. The reflection apparatus of claim 3, wherein the first mirror further comprises a first transparent protection layer laminated on the first reflection layer.

6. The reflection apparatus of claim 4, wherein the second mirror further comprises a second transparent protection layer laminated on the second reflection layer.

7. The reflection apparatus of claim 1, further comprising a rotation shaft connected with the first mirror and the second mirror,
wherein at least one of the first mirror and the second mirror rotates with respect to the rotation shaft.

8. The reflection apparatus of claim 1, wherein respective reflection surfaces of the first mirror and the second mirror are any one of a combination of aspheric and concave surfaces, a combination of aspheric and convex surfaces, a combination of aspheric and planar surfaces, and a combination of planar and aspheric surfaces.

9. The reflection apparatus of claim 1, wherein an angle formed by the first mirror and an optical axis of the projection optical system is in a range of 15° through 32°.

10. The reflection apparatus of claim 1, wherein an angle between the first mirror and the second mirror is in a range of 96° through 106°.

11. A beam projector comprising:
a projection optical system; and
a reflection apparatus that reflects and projects incident light from the projection optical system to an external surface,
wherein the reflection apparatus comprises:
a first mirror for reflecting the incident light from the projection optical system; and
a second mirror that receives the light reflected from the first mirror and reflects the received light to the external surface.
